(19) United States
(12) Patent Application Publication
(10) Pub. No.: US 2017/0207486 A1
(43) Pub. Date: Jul. 20, 2017

(54) ELECTROLYTES FOR LITHIUM TRANSITION METAL PHOSPHATE BATTERIES

(71) Applicant: BASF Corporation, Florham Park, NJ (US)

(72) Inventors: MeiMei WU, Jiangsu (CN); Xueshan HU, Jiangsu (CN)

(73) Assignee: BASF Corporation, Florham Park, NJ (US)

(21) Appl. No.: 15/324,059

(22) PCT Filed: Jul. 23, 2014
(86) PCT No.: PCT/CN2014/082797

§ 371 Date: Jan. 5, 2017

(51) Int. Cl. H01M 10/0567; H01M 10/0525; H01M 10/0569; H01M 4/58; H01M 10/0568

(52) U.S. Cl. CPC H01M 10/0567; H01M 4/5825; H01M 10/0568; H01M 10/0569; H01M 10/0525; H01M 2300/004

(57) ABSTRACT

Electrolytic solutions and secondary batteries containing same are provided. The electrolytic solutions contain an additive consisting of one or more C₅-C₇ monocycloalkane compounds and derivatives thereof.

### TECHNICAL FIELD

The present invention relates to non-aqueous electrolytic solutions and secondary (rechargeable) electrochemical energy storage devices comprising the same. Such electrolytic solutions enhance electrochemical performance in devices charged to higher voltages, reduce capacity degradation during cycling at these voltages and during high temperature storage and in general improve the overall electrochemical stability of a device made therewith. More specifically the present invention relates to rechargeable batteries that contain one or more lithium transition metal phosphate cathode active materials and contain non-aqueous electrolyte compositions comprising (a) one or more ionic salts; (b) one or more solvents; and (c) and an additive consisting of one or more C₅-C₇ monocycloalkane compounds and derivatives thereof.

### BACKGROUND

Lithium compound containing electric cells and batteries containing such cells are modern means for energy storage devices. For example, lithium ion batteries have been have been widely used as high energy density sources in many consumer electronics applications, such as portable phones, camcorders, notebook computers and a host of other portable electronic consumer products.

Electrolytes for lithium compound containing energy storage devices are mixtures comprised of one or more highly soluble lithium salts and inorganic additives dissolved in one or more organic solvents. Electrolytes are responsible for ionic conduction between the cathode and the anode in the battery and thus essential to the operation of the system. More research and development on lithium transition metal phosphate batteries is being carried out in order to meet high energy density requirements for new application fields such as power tools, electric vehicles (EV), hybrid electric vehicles (HEV) and plug-in hybrid electric vehicles (PHEV). Further research and development on lithium transition metal phosphates (LiMPO₄) such as LiFePO₄ (LFP) is being carried out in order to meet high power density requirements for these new applications. Other important factors for using LiMPO₄ cathode materials as higher power sources are high safety, low cost and environmentally benign properties. However, impedance growth and capacity loss of lithium-ion batteries at elevated temperatures or in battery cycle performance are still difficult problems for high energy density sources.

### SUMMARY

This invention relates to non-aqueous electrolyte compositions comprising (a) one or more ionic salts; (b) one or more solvents; and (c) an additive consisting of one or more C₅-C₇ monocycloalkane compounds and derivatives thereof.

An embodiment of this invention is a secondary battery comprising:
a. an anode,
b. a lithium transition metal phosphate cathode and,
c. an electrolytic solution, comprising a non-aqueous electrolytic solvent comprising (i) one or more ionic salts; (ii) one or more solvents; and (iii) an additive consisting of one or more C₅-C₇ monocycloalkane compounds and derivatives thereof.

A further embodiment involves non-aqueous electrolytic solutions suitable for use in electrochemical energy storage devices (e.g., lithium metal batteries, lithium ion batteries, lithium ion capacitors and supercapacitors) that may include salts, solvents, and may also include solid electrolyte interphase (SEI) formers, fluorinated compounds, compounds that promote high temperature stability, as well as performance enhancing additives such as overcharge protection agents, non-flammable agents, anti-swelling agent, and low temperature performance enhancers.

An embodiment provides an electrolytic solution useful in a lithium transition metal phosphate lithium-ion batteries, particularly those having a cathode comprised of lithium iron phosphate material.

One more embodiment provides batteries that include an anode, cathode, separator between anode and cathode and an electrolyte solution. The major components, including salts, solvents, additives, anodes, cathodes and separators, are each described in turn herein below.

One additional embodiment provides non-aqueous electrolytic solutions that have high voltage stability during room temperature and high temperature cell cycling as well as good performance under high temperature storage conditions.

### BRIEF DESCRIPTION OF THE DRAWINGS

FIG. 1 shows cycle curves of lithium-ion batteries according to examples 3, 4 and comparative example 1 up to 500 cycles.

FIG. 2 shows cycle curves of lithium-ion batteries according to example 4 and comparative example 1 up to 1500 cycles.

FIG. 3 shows cycle curves of lithium-ion batteries according to examples 1, 2 and comparative example 1 up to 500 cycles.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

Reference throughout this specification to “one embodiment,” “certain embodiments,” “one or more embodiments” or “an embodiment” means that a particular feature, structure, material, or characteristic described in connection with the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Furthermore, the particular features, structures, materials, or characteristics may be combined in any suitable manner in one or more embodiments.

Although the invention herein has been described with reference to particular embodiments, it is to be understood that these embodiments are merely illustrative of the principles and applications of the present invention. It will be apparent to those skilled in the art that various modifications and variations can be made to the method and apparatus of the present invention without departing from the spirit and scope of the invention. Thus, it is intended that the present invention include modifications and variations that are within the scope of the appended claims and their equivalents.

C₅-C₇ Cycloalkanes and Derivatives Thereof.

The C₅-C₇ monocycloalkanes and derivatives thereof are represented by the following chemical formulae:

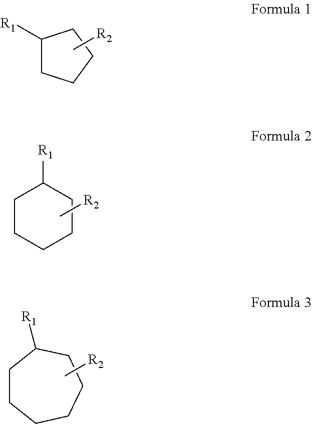

wherein R₁, and R₂, are each independently H, C₁-C₁₀ alkyl, halogen groups.

Preferably, the R₁ and R₂ alkyl substituents are independently C₁-C₈ alkyl, preferably C₁-C₄ alkyl moieties. Alkyl includes linear or branched alkyl, and non-limiting examples include methyl, ethyl, propyl, butyl, pentyl, hexyl, heptyl, octyl, nonyl, and decyl. Non-limiting examples of branched alkyl substituent groups include —CH(CH₃)₂, —CH(CH₃)(CH₂CH₃), —CH(CH₂CH₃)₂, —C(CH₃)₃, —C(CH₂CH₃)₃, —CH₂CH(CH₃)₂, —CH₂CH(CH₃)(CH₂CH₃), —CH₂CH(CH₂CH₃)₂, —CH₂C(CH₃)₃, —CH₂C(CH₂CH₃)₃, —CH(CH₃)CH(CH₃)CH₂CH₃), —CH₂CH₂CH(CH₃)₂, —CH₂CH₂CH(CH₃)(CH₂CH₃), —CH₂CH₂CH(CH₂CH₃)₂, —CH₂CH₂C(CH₃)₃, —CH₂CH₂C(CH₂CH₃)₃, —CH(CH₃)CH₂CH(CH₃)₂, —CH(CH₃)CH(CH₃)CH(CH₃)₂, and —CH(CH₂CH₃)CH(CH₃)CH(CH₃)(CH₂CH₃). In a preferred embodiment R₁ an ethyl and R₂ is hydrogen, particularly preferred is ethylcyclohexane.

Specific examples include cyclopentane, cyclohexane, cycloheptane, methylcyclopentane, 1,3-dimethylcyclopentane, 1,1,3-trimethylcyclopentane, ethylcyclopentane, methylcyclohexane, 1,1-dimethylcyclohexane, 1,3-dimethylcyclohexane, 1,4-dimethylcyclohexane, ethylcyclohexane, propylcyclopentane, 1,1,3-trimethylcyclohexane, 1-t-butyl-1-methylcyclohexane, 1,2-dimethylcyclohexane, 1-ethyl-3-methylcyclohexane, 1-ethyl-4-methylcyclohexane, propylcyclohexane, 1,3-diethyl-cyclohexane, 1,4-diethyl-cyclohexane, 1-methyl-3-isopropylcyclohexane, butylcyclohexane, 1,3-diethyl-5-methylcyclohexane, 1-ethyl-2-propylcyclohexane, pentylcyclohexane, 1,3,5-triethylcyclohexane, 1-methyl-4-pentylcyclohexane, hexylcyclohexane, 1,3-diethyl-5-pentylcyclohexane, 1-methyl-2-hexyl-cyclohexane, heptylcyclohexane, 13-dipropyl-5-ethylcyclohexane, 1-methyl-4-heptylcyclohexane, octylcyclohexane, 1,3,5-tripropylcyclohexane, 1-methyl-2-octylcyclohexane, nonylcyclohexane, 1,3-propyl-5-butylcyclohexane, 1-methyl-4-nonylcyclohexane, decylcyclohexane, bromocyclohexane, 4-isopropyl-1-methyl-1-bromo-2-bromocyclohexene, 3-chloro-1,1-dimethylcyclohexane, 2-bromo-3-chloro-1,1-dimethylcyclohexane, 1-chloro-2-ethylcyclohexane, 2-bromo-1,1-dimethylcyclohexane, 2-floro-1,1-dimethylcyclohexane and, 1-chloro-2-methylcyclopentane, 2-bromo-1-chloro-3-m ethylcyclopentane, and 1-ethyl-3-methylcycloheptane.

In one further embodiment of the invention, the content of the cycloalkane additives is 0.1-10% preferably 0.1-7%, more preferably 0.2%-5% based on the total weight of the electrolyte.

A further embodiment involves non-aqueous electrolytic solutions suitable for use in electrochemical energy storage devices (e.g., lithium metal batteries, lithium ion batteries, lithium ion capacitors and supercapacitors) that include salts, solvents, C₅-C₇ monocyclohexanes (represented by formula 2) and may additionally include solid electrolyte interphase (SEI) formers, fluorinated compounds, compounds that promote high temperature stability, as well as performance enhancing additives such as overcharge protection agents, non-flammable agents, anti-swelling agent, and low temperature performance enhancers.

Preferably, the additive can further comprise vinylene carbonate, prop-1-ene-1,3-sultone or combinations thereof. Preferably, the content of vinylene carbonate is 1-5 wt % based on the total weight of the electrolyte.

In one preferred embodiment of the invention, the additive comprises the compound of formula 2 and vinylene carbonate (VC), wherein the content of the compound of formulae 2 is 0.1-10 wt %, preferably 0.1-7 wt % based on the weight of the electrolyte. Preferably, the compound of formulae 2 is ethylcyclohexane.

Salts. The solute of the electrolytic solution of the invention contain an ionic salt containing at least one positive ion. Typically this positive ion is lithium (Li+). The salts herein function to transfer charge between the negative electrode and the positive electrode of the battery system. The lithium salts are preferably halogenated, for example, LiPF₆, LiBF₄, LiSbF₆, LiAsF₆, LiTaF₆, LiAlCl₄, Li₂B₁₀Cl₁₀, Li₂B₁₀F₁₀, LiClO₄, LiCF₃SO₃, Li₂B₃₂FₓH₍₁₂₋ₓ₎ wherein x=0-12; LiPFₓ(RF)₆₋ₓ and LiBF_{y}(RF)_{4-y} wherein RF represents perfluorinated C₁-C₂₀ alkyl groups or perfluorinated aromatic groups, x=0-5 and y=0-3, LiBF₂[O₂C(CX₂)ₙCO₂], LiPF₂[O₂C(CX₂)ₙCO₂]₂, LiPF₄[O₂C(CX₂)ₙCO₂], wherein X is selected from the group consisting of H, F, Cl, C₁-C₄ alkyl groups and fluorinated alkyl groups, and n=0-4, LiN(SO₂CₘF₂ₘ₊₁)(SO₂CₙF₂ₙ₊₁), and LiC(SO₂CₖF₂ₖ₊₁)(SO₂CₘF₂ₘ₊₁)(SO₂CFₙF₂ₙ₊₁), wherein k=1-10, m=1-10, and n=1-10, respectively, LiN(SO₂CₚF₂ₚSO₂), and LiC(SO₂CₚF₂ₚSO₂)(SO₂V_{2q+1}) wherein p=1-10 and q=1-10, lithium salts of chelated orthoborates and chelated orthophosphates such as lithium bis(oxalato)borate [LiB(C₂O₄)₂], lithium bis(malonato) borate [LiB(O₂CCH₂CO₂)₂], lithium bis(difluoromalonato) borate [LiB(O₂CCF₂CO₂)₂], lithium (malonato oxalato) borate [LiB(C₂O₄)(O₂CCH₂CO₂)], lithium (difluoromalonato oxalato) borate [LiB(C₂O₄)(O₂CCF₂CO₂)], lithium tris(oxalato) phosphate [LiP(C₂O₄)₃], and lithium tris(difluoromalonato) phosphate [LiP(O₂CCF₂CO₂)₃], and any combination of two or more of the aforementioned salts.

In one embodiment of the invention, the concentration of the lithium salt in the electrolyte is 0.5-2 mol/L, preferably 0.8-1.5 mol/L.

Preferably, the lithium salt is selected from the group consisting of lithium hexafluorophosphate (LiPF₆), lithium bis(oxalate)borate (LiBOB), lithium difluoro(oxalato)borate (LiODFB), lithium tetrafluoroborate (LiBF₄), lithium perchlorate (LiClO₄), lithium trifluoromethanesulfonate (LiCF₃SO₃), bis(trifluoromethane)sulfonimide lithium (LiTFSI) and combinations thereof.

In more preferred embodiment of the invention, the lithium salt is selected from the group consisting of lithium hexafluorophosphate, lithium bis(oxalate)borate, lithium difluoro(oxalato)borate, lithium tetrafluoroborate and combination thereof. Particularly, the concentration of the lithium salt in the electrolyte is 0.8-1.5 mol/L.

In even more preferred embodiment of the invention, the lithium salt is selected from the group consisting of lithium hexafluorophosphate (LiPF₆), lithium tetrafluoroborate (LiBF4) and combination thereof. More preferably, the lithium salt is a mixture of lithium hexafluorophosphate (LiPF₆) and lithium tetrafluoroborate (LiBF₄), and the total concentration of both is 0.5-2 mol/L, preferably 0.8-1.5 mol/L.

Most preferably the electrolytic solution comprises LiPF₆ as the ionic salt. The amount of salt is between 5% to 20% of the total electrolyte weight, more preferably, the amount of salt is between 10% to 15% of the total electrolyte weight.

Solvents.

The solvents to be used in the secondary batteries of the invention can be any of a variety of non-aqueous, aprotic, and polar organic compounds. Generally, solvents may be carbonates, carboxylates, ethers, lactones, sulfones, phosphates, nitriles, and ionic liquids. Useful carbonate solvents herein include, but are not limited to: cyclic carbonates, such as propylene carbonate and butylene carbonate, and linear carbonates, such as dimethyl carbonate, diethyl carbonate, dipropyl carbonate, dibutyl carbonate, ethyl methyl carbonate, methyl propyl carbonate, and ethyl propyl carbonate. Useful carboxylate solvents include, but are not limited to: methyl formate, ethyl formate, propyl formate, butyl formate, methyl acetate, ethyl acetate, propyl acetate, butyl acetate, methyl propionate, ethyl propionate, propyl propionate, butyl propionate, methyl butyrate, ethyl butyrate, propyl butyrate, and butyl butyrate. Useful ethers include, but are not limited to: tetrahydrofuran, 2-methyl tetrahydrofuran, 1,3-dioxolane, 1,4-dioxane, 1,2-dimethoxyethane, 1,2-diethoxyethane, 1,2-dibutoxyethane, methyl nonafluorobutyl ether, and ethyl nonafluorobutyl ether. Useful lactones include, but are not limited to: γ-butyrolactone, 2-methyl-γ-butyrolactone, 3-methyl-γ-butyrolactone, 4-methyl-γ-butyrolactone, β-propiolactone, and δ-valerolactone. Useful phosphates include, but are not limited to: trimethyl phosphate, triethyl phosphate, tris(2-chloroethyl) phosphate, tris(2,2,2-trifluoroethyl) phosphate, tripropyl phosphate, triisopropyl phosphate, tributyl phosphate, trihexyl phosphate, triphenyl phosphate, tritolyl phosphate, methyl ethylene phosphate, and ethyl ethylene phosphate. Useful sulfones include, but are not limited to: non-fluorinated sulfones, such as dimethyl sulfone and ethyl methyl sulfone, partially fluorinated sulfones, such as methyl trifluoromethyl sulfone, ethyl trifluoromethyl sulfone, methyl pentafluoroethyl sulfone, and ethyl pentafluoroethyl sulfone, and fully fluorinated sulfones, such as di(trifluoromethyl) sulfone, di(pentafluoroethyl) sulfone, trifluoromethyl pentafluoroethyl sulfone, trifluoromethyl nonafluorobutyl sulfone, and pentafluoroethyl nonafluorobutyl sulfone. Useful nitriles include, but are not limited to: acetonitrile, propionitrile, butyronitrile and dinitriles, CN[CH₂]ₙCN with various alkane chain lengths (n=1-8). An ionic liquid (IL) is a salt in the liquid state. In some contexts, the term has been restricted to salts whose melting point is below some arbitrary temperature, such as 100° C. (212° F.). ILs are largely made of ions and short-lived ion pairs. Common anions of ILs are TFSi, FSi, BOB, PF₆₋ₓRₓ, BF₄, etc and cations of ILs are imidazolium, piperidinium, pyrrolidinium, tetraalkylammonium, morpholinium, etc. Useful ionic liquids include, but not limited to: Bis(oxalate)borate (BOB) anion based ionic liquids, such as N-cyanoethyl-N-methylprrrolidinium BOB, 1-methyl-1-(2-methylsulfoxy)ethyl)-pyrrolidinium BOB, and 1-methyl-1-((1,3,2-dioxathiolan-2-oxide-4-yl)methyl)pyrrolidinium BOB; tris(pentafluoroethyl)trifluorophosphate (FAP) anion based ionic liquids, such as N-allyl-N-methylpyrrrolidinium FAP, N-(oxiran-2-ylmethyl)N-methylpyrrolidinium FAP, and N-(prop-2-inyl)N-methylpyrrolidinium FAP; bis(trifluoromethanesulfonyl)imide (TFSI) anion-based ionic liquids, such as N-propyl-N-methylpyrrolidinium TFSI, 1,2-dimethyl-3-propylimidazolium TFSI, 1-octyl-3-methyl-imidazolium TFSI, and 1-butyl-methylpyrrolidinium TFSI; Bis(fluorosulfonyl)imide (FSI) anion-based ionic liquids, such as N-Butyl-N-methylmorpholinium FSI and N-propyl-N-methylpiperidinium FSI; and other ionic liquids such as 1-ethyl-3-methylimidazolium tetrafluoroborate. Two or more of these solvents may be used in the electrolytic solution. Other solvents may be utilized as long as they are non-aqueous and aprotic, and are capable of dissolving the salts, such as N,N-dimethyl formamide, N,N-dimethyl acetamide, N,N-diethyl acetamide, and N,N-dimethyl trifluoroacetamide. Carbonates are preferred, with the most preferred being ethylene carbonate (EC), ethyl methyl carbonate (EMC) and mixtures thereof. The amount of solvent is between 70% to 95% of the total electrolyte weight, more preferably, the amount of salt is between 80% to 90% of the total electrolyte weight.

In one embodiment of the invention, the non-aqueous solvent is selected from the group consisting of ethylene carbonate (EC), propylene carbonate (PC), methyl ethyl carbonate (EMC), dimethyl carbonate (DMC), diethyl carbonate (DEC), γ-butyrolactone (GBL), methyl propyl carbonate (MPC), methyl formate (MF), ethyl formate (EF), methyl acetate (MA), ethyl acetate (EA), ethyl propionate (EP), ethyl butyrate (EB), acetonitrile (AN), N,N-dimethyllformamide (DMF) and combination thereof. The combination of two or more solvents above is preferred.

In one preferred embodiment of the invention, the non-aqueous organic solvent is a mixture of two or more solvents selected from the group consisting of ethylene carbonate (EC), propylene carbonate (PC), methyl ethyl carbonate (EMC), dimethyl carbonate (DMC), and diethyl carbonate (DEC). Preferably, the non-aqueous organic solvent comprises 5-20 wt % ethylene carbonate, 20-50 wt % methyl ethyl carbonate, and 20-60 wt % dimethyl carbonate.

Solid Electrolyte Interphase (SEI) Formers.

SEI formers are materials that can be reductively decomposed on surfaces of negative electrodes prior to other solvent components to form protective films that suppress excessive decomposition of the electrolytic solutions. SEI has important roles on the charge/discharge efficiency, the cycle characteristics and the safety of nonaqueous electrolyte batteries. Generally, SEI formers can include, but not limited to, vinylene carbonate and its derivatives, ethylene carbonate derivatives having non-conjugated unsaturated bonds in their side chains, halogen atom-substituted cyclic carbonates and salts of chelated orthoborates and chelated orthophosphates. Specific examples of SEI additives include vinylene carbonate (VC), vinylethylene carbonate (VEC), methylene ethylene carbonate (or 4-vinyl-1,3-dioxolan-2-one) (MEC), monofluoroethylene carbonate (FEC), Chloroethylene carbonate (CEC), 4,5-divinyl-1,3-dioxolan-2-one, 4-methyl-5-vinyl-1,3-dioxolan-2-one, 4-ethyl-5-vinyl-1,3-dioxolan-2-one, 4-propyl-5-vinyl-1,3-dioxolan-2-one, 4-butyl-5-vinyl-1,3-dioxol an-2-one, 4-pentyl-5-vinyl-1,3-dioxol an-2-one, 4-hexyl-5-vinyl-1,3-dioxolan-2-one, 4-phenyl-5-vinyl-1,3-dioxolan-2-one, 4,4-difluoro-1,3-dioxolan-2-one and 4,5-difluoro-1,3-dioxolan-2-one, lithium bis(oxalate)borate (LiBOB), lithium bis(malonato)borate (LiBMB), lithium bis(difluoromalonato)borate (LiBDFMB), lithium (malonato oxalato)borate (LiMOB), lithium (difluoromalonato oxalato)borate (LiDFMOB), lithium tris(oxalato)phosphate (LiTOP), and lithium tris(difluoromalonato)phosphate (LiTDFMP). Particularly useful solid electrolyte interphase formers are selected from the group consisting of vinylene carbonate, monofluoroethylene carbonate, methylene ethylene carbonate, vinyl ethylene carbonate, lithium bis(oxalate)borate and mixtures thereof. The amount of SEI former is between 0.1% to 8% of the total electrolyte weight, more preferably, the amount of SEI former is between 1% to 5% of the total electrolyte weight.

Fluorinated Compounds.

Fluorinated compounds can include organic and inorganic fluorinated compounds. Each provided in an amount of 0 to 50% by weight of the electrolyte solution.

Organic Fluorinated Compounds—

Compounds in the organic family of fluorinated compounds can include fluorinated carbonates, fluorinated ethers, fluorinated esters, fluorinated alkanes, fluorinated alkyl phosphates, fluorinated aromatic phosphates, fluorinated alkyl phosphonates, and fluorinated aromatic phosphonates. Exemplary organic fluorinated compounds include fluorinated alkyl phosphates, such as tris(trifluoroethyl)phosphate, tris(1,1,2,2-tetrafluoroethyl) phosphate, tri s (hexafluoro-isopropyl)phosphate, (2,2,3,3-tetrafluoropropyl) dimethyl phosphate, bis(2,2,3,3-tetrafluoropropyl) methyl phosphate, and tris(2,2,3,3-tetrafluoropropyl) phosphate; fluorinated ethers, such as 3-(1,1,2,2-tetrafluoroethoxy)-(1,1,2,2-tetrafluoro)-propane, pentafluoropropyl methyl ether, pentafluoropropyl fluoromethyl ether, pentafluoropropyl trifluoromethyl ether, 4,4,4,3,3,2,2-heptafluorobutyl difluoromethyl ether, 4,4,3,2,2-pentafluorobutyl 2,2,2-trifluoroethyl ether, 2-difluoromethoxy-1,1,1-trifluoroethane, and 2-difluoromethoxy-1,1,1,2-tetrafluoroethane; fluorinated carbonates, such as fluoroethylene carbonate, bis(fluoromethyl) carbonate, bis(fluoroethyl) carbonate, fluoroethyl fluoromethyl carbonate, methyl fluoromethyl carbonate, ethyl fluoroethyl carbonate, ethyl fluoromethyl carbonate, methyl fluoroethyl carbonate, bis(2,2,2-trifluoroethyl) carbonate, 2,2,2-trifluoroethyl methyl carbonate, fluoroethylene carbonate, and 2,2,2-trifluoroethyl propyl carbonate. Also suitable are fluorinated esters, such as (2,2,3,3-tetrafluoropropyl) formate, methyl trifluoroacetate, ethyl trifluoroacetate, propyl trifluoroacetate, trifluoromethyl trifluoroacetate, trifluoroethyl trifluoroacetate, perfluoroethyl trifluoroacetate, and (2,2,3,3-tetrafluoropropyl) trifluoroacetate; fluorinated alkanes, such as n-C₄F₉C₂H₅, n-C₆F₁₃C₂H₅, or n-C₈F₁₆H; fluorinated aromatic phosphates, such as tris(4-fluorophenyl) phosphate and pentafluorophenyl phosphate. Fluorinated alkyl phosphonate, such as trifluoromethyl dimethylphosphonate, trifluoromethyl di(trifluoromethyl)phosphonate, and (2,2,3,3-tetrafluoropropyl) dimethylphosphonate; fluorinated aromatic phosphonate, such as phenyl di(trifluoromethyl)phosphonate and 4-fluorophenyl dimethylphosphonate, are suitable. Combinations of two or more of any of the foregoing are also suitable.

Inorganic Fluorinated Compounds—

Compounds in the inorganic family of fluorinated compounds include lithium salts of fluorinated chelated orthoborates, fluorinated chelated orthophosphates, fluorinated imides, fluorinated sulfonates. Exemplary inorganic fluorinated compounds include LiBF₂C₂O₄ (LiDFOB), LiPF₄(C₂O₄) (LiTFOP), LiPF₂(C₂O₄)₂ (LiDFOP), LiN(SO₂CF₃)₂ (LiTFSI), LiN(SO₂F)₂ (LiFSI), LiN(SO₂C₂F₅)₂ (LiBETI), LiCF₃SO₃, Li₂B₃₂FₓH₍₁₂₋ₓ₎ where 0<x≦12 and combinations of two or more thereof.

Compounds that Promote High Temperature Stability.

When batteries are operated or stored at 55° C. or above, they tend to have poor capacity retention and swelling phenomenon due to gas generation that results from decomposition of the electrolyte at the cathode. This reduced performance becomes more evident when a cell is charged to higher voltages. High temperature stabilizers can enhance charge-discharge characteristics of batteries and effectively reduce the swelling of batteries at elevated temperatures. They can also help to create a protective layer on the surface of the cathode which will further decrease the amount of solvent oxidation and decomposition at the cathode. Compounds that promote high temperature stability typically include: sulfur-containing linear and heterocyclic, unsaturated and saturated compounds; phosphorus containing linear and heterocyclic, unsaturated and saturated compounds; and compounds that act as HF scavengers.

Sulfur containing compounds include linear and cyclic compounds such as sulfites, sulfates, sulfoxides, sulfonates, thiophenes, thiazoles, thietanes, thietes, thiolanes, thiazolidines, thiazines, sultones, and sulfones. These sulfur containing compounds can include various degrees of fluorine substitution up to and including the fully perfluorinated compounds. Specific examples of sulfur-containing linear and cyclic compounds include ethylene sulfite, ethylene sulfate, thiophene, benzothiophene, benzo [c]thiophene, thiazole, dithiazole, isothiazole, thietane, thiete, dithietane, dithiete, thiolane, dithiolane, thiazolidine, isothiazolidine, thiadiazole, thiane, thiopyran, thiomorpholine, thiazine, dithiane, dithiine; thiepane; thiepine; thiazepine; prop-1-ene-1,3-sultone; propane-1,3-sultone; butane-1,4-sultone; 3-hydroxy-1-phenylpropanesulfonic acid 1,3-sultone; 4-hydroxy-1-phenylbutanesulfonic acid 1,4-sultone; 4-hydroxy-1-methylbutanesulfonic acid 1,4 sultone; 3-hydroxy-3-methylpropanesulfonic acid 1,4-sultone; 4-hydroxy-4-methylbutanesulfonic acid 1,4-sultone; a sulfone having the formula R₁(═S(═O)₂)R₂ where R₁ and R₂ are independently selected from the group consisting of substituted or unsubstituted, saturated or unsaturated C₁ to C₂₀ alkyl or aralkyl groups; and combinations of two or more thereof. In a specific embodiment the sulfur containing compounds (are selected from the group consisting propane-1,3-sultone, butane-1,4-sultone and prop-1-ene-1,3-sultone, each provided in an amount of 0.1 to 5.0% by weight of the electrolyte solution.

Phosphorus containing compounds include linear and cyclic, phosphates and phosphonates. Representative examples of the phosphorus containing compounds include: alkyl phosphates, such as trimethylphosphate, triethylphosphate, triisopropyl phosphate, propyl dimethyl phosphate, dipropyl methyl phosphate, and tripropyl phosphate; aromatic phosphates, such as triphenyl phosphate; alkyl phosphonates include trimethylphosphonate, and propyl dimethylphosphonate; and aromatic phosphonates, such as phenyl dimethylphosphonate. Combinations of any of the foregoing are also suitable. The amount of phosphorus containing compounds is between 0.1% to 5% of the total electrolyte weight, more preferably, the amount of phosphorus containing compounds is between 1% to 4% of the total electrolyte weight.

Compounds that promote high temperature stability also include additives that work as a HF scavenger to prevent battery capacity deterioration and improve output characteristics at high temperatures, including acetamides, anhydrides, Pyridines, tris(trialkylsilyl)phosphates, tris(trialkylsilyl)phosphites, tris(trialkylsilyl)borates. Examples of HF scavenger-type high temperature stabilizers include: acetamides such as, N,N-dimethyl acetamide, and 2,2,2-trifluoroacetamide; anhydrides such as phthalic anhydride succinic anhydride, and glutaric anhydride; pyridines such as antipyridine and pyridine; tris(trialkylsilyl)phosphates such as tris(trimethylsilyl)phosphate and tris(triethylsilyl)phosphate; tris(trialkylsilyl)phosphites tris(trimethylsilyl)phosphite, tris(triethylsilyl)phosphite, tris(tripropylsilyl)phosphit; tris(trialkylsilyl)borates such as, tris(trimethylsilyl)borate, tris(triethylsilyl)borate, and tris(tripropylsilyl)borate; alone or as a mixture of two or more thereof. The amount of compounds that promote high temperature stability is between 0.1% to 5% of the total electrolyte weight, more preferably, the amount of compounds that promote high temperature stability is between 1% to 4% of the total electrolyte weight.

An embodiment of this invention includes a secondary electrochemical energy storage device electrolyte which comprises:
a. ethylene carbonate, dimethyl carbonate and ethylmethyl carbonate;
b. LiPF₆; and
c. an additive consisting of one or more C₅-C₇ monocycloalkane compounds and derivatives thereof.

Anodes.

The anode material is selected from lithium metal, lithium alloys, carbonaceous materials, and lithium metal oxides capable of being intercalated and de-intercalated with lithium ions. Carbonaceous materials useful herein include graphite, amorphous carbon, and other carbon materials such as activated carbon, carbon fiber, carbon black, and mesocarbon microbeads. Lithium metal anodes may be used. Lithium MMOs (mixed-metal oxides) such as LiMnO₂ and Li₄Ti₅O₁₂ are also envisioned. Alloys of lithium with transition or other metals (including metalloids) may be used, including LiAl, LiZn, Li₃Bi, Li₃Cd, Li₃Sb, Li₄Si, Li_{4.4}Pb, Li_{4.4}Sn, LiC₆, Li₃FeN₂, Li_{2.6}Co_{0.4}N, Li_{2.6}Cu_{0.4}N, and combinations thereof. The anode may further comprise an additional material such as a metal oxide including SnO, SnO₂, GeO, GeO₂, In₂O, In₂O₃, PbO, PbO₂, Pb₂O₃, Pb₃O₄, Ag₂O, AgO, Ag₂O₃, Sb₂O₃, Sb₂O₄, Sb₂O₅, SiO, ZnO, CoO, NiO, FeO, and combinations thereof. Silicon may also be used.

Cathodes.

The cathode comprises at least one, lithium transition metal phosphate (LiMPO₄) Lithium transition metal phosphate (LiMPO₄) such as LiFePO₄, LiVPO₄, LiMnPO₄, LiCoPO₄, LiNiPO₄, LiMnₓMc_{y}PO₄, where Mc may be one of or of Fe, V, Ni, Co, Al, Mg, Ti, B, Ga, or Si and 0<x,y<1. Furthermore, transition metal oxides such as MnO₂ and V₂O₅, transition metal sulfides such as FeS₂, MoS₂, and TiS₂, and conducting polymers such as polyaniline and polypyrrole may be present. The preferred positive electrode materials are LiFePO₄ and LiMnPO₄. Preferably, the active cathode material is LiFePO₄.

Either the anode or the cathode, or both, may further comprise a polymeric binder. In the preferred embodiment, the binder may be polyvinylidene fluoride, styrene-butadiene rubber, alkali metal salts of carboxymethyl cellulose, alkali metal salts of polyacrylic acid, polyamide or melamine resin, or combinations of two or more thereof.

Further additions to the electrolytic solution may include, but are not limited to, one or more of the following performance enhancing additives: overcharge protection agent, non-flammable agents, anti-swelling agent, low temperature performance enhancers. Examples of such compounds include biphenyl, iso-propyl benzene, hexafluorobenzene, phosphazenes, organic phosphates, organic phosphonates, and alkyl and aryl siloxanes, The total concentration of such additives in the solution preferably does not exceed about 5 wt %.

In one embodiment of the invention, the separator placed between the cathode and the anode which allows for the transfer of ions through the electrolyte solution between the cathode and anode is selected from the group consisting of polyethylene film, polypropylene film and combinations thereof.

Certain embodiments of the invention are envisioned where at least some percentages, temperatures, times, and ranges of other values are preceded by the modifier “about.” “Comprising” is intended to provide support for “consisting of” and “consisting essentially of.” Where ranges in the claims of this provisional application do not find explicit support in the specification, it is intended that such claims provide their own disclosure as support for claims or teachings in a later filed non-provisional application. Numerical ranges of ingredients that are bounded by zero on the lower end (for example, 0-10 vol % VC) are intended to provide support for the concept “up to [the upper limit],” for example “up to 10 vol % VC,” vice versa, as well as a positive recitation that the ingredient in question is present in an amount that does not exceed the upper limit. An example of the latter is “comprises VC, provided the amount does not exceed 10 vol %.” A recitation such as “8-25 vol % (EC+MEC+VC)” means that any or all of EC, MEC and/or VC may be present in an amount of 8-25 vol % of the composition.

### EXAMPLES OF THE INVENTION

### Example 1

The electrolyte solution is prepared in BRAUN glove box with argon gas of 99.999% purity and water content of ≦5 ppm at room temperature, wherein 12.73 g ethylene carbonate, 40.73 g ethyl methyl carbonate, 31.40 g dimethyl carbonate, 2 g vinylene carbonate and 0.5 g cyclohexane are mixed evenly, and then LiPF₆ is added and mixed sufficiently to obtain 1.0 mol/L of LiPF₆ solution.

### Example 2

The procedure of example 2 is the same as example 1, except that 12.45 g ethylene carbonate, 40.10 g ethyl methyl carbonate, 30.91 g dimethyl carbonate, 2 g vinylene carbonate and 2 g cyclohexane are mixed evenly, and then LiPF₆ is added and mixed sufficiently to obtain 1.0 mol/L of LiPF₆ solution.

### Example 3

The procedure of example 3 is the same as example 1, except that 12.73 g ethylene carbonate, 40.73 g ethyl methyl carbonate, 31.40 g dimethyl carbonate, 2 g vinylene carbonate and 0.5 g ethylcyclohexane are mixed evenly, and then LiPF₆ is added and mixed sufficiently to obtain 1.0 mol/L of LiPF₆ solution.

### Example 4

The procedure of example 4 is the same as example 1, except that 12.45 g ethylene carbonate, 40.10 g ethyl methyl carbonate, 30.91 g dimethyl carbonate, 2 g vinylene carbonate and 2 g ethylcyclohexane are mixed evenly, and then LiPF₆ is added and mixed sufficiently to obtain 1.0 mol/L of LiPF₆ solution.

### Example 5

The procedure of example 5 is same as example 1, except that 12.40 g ethylene carbonate, 39.68 g ethyl methyl carbonate, 30.59 g dimethyl carbonate, 2 g vinylene carbonate, 3 g ethylcyclohexane are mixed evenly, and then LiPF₆ is added and mixed sufficiently to obtain 1.0 mol/L of LiPF₆ solution.

### Example 6

The procedure of example 6 is the same as example 1, except that 12.14 g ethylene carbonate, 38.85 g ethyl methyl carbonate, 29.95 g dimethyl carbonate, 2 g vinylene carbonate and 5 g ethylcyclohexane are mixed evenly, and then LiPF₆ is added and mixed sufficiently to obtain 1.0 mol/L of LiPF₆ solution.

### Comparison Example 1

The electrolyte solution is prepared in BRAUN glove box with argon gas of 99.999% purity and water content of ≦5 ppm at room temperature, wherein 12.79 g ethylene carbonate, 40.94 g ethyl methyl carbonate, 31.56 g dimethyl carbonate and 2 g vinylene carbonate are mixed evenly, and then LiPF₆ is added and mixed sufficiently to obtain 1.0 mol/L of LiPF₆ solution.

### Test and Results

The dry cell comprises LiFePO₄ as cathode and AG (Artificial Graphite) as anode and purchased from TianJin BAK Battery CO., LTD and the design capacity of the lithium ion battery is 1000 mAh. Dry cell is placed in the oven of 85° C. for 24 hours and then transferred to glove box for use. The electrolyte solutions prepared according to examples and comparative examples are injected into dried cell, then sealing and remained for 24 hours, and formation, to obtain the lithium ion batteries.

### Performance Test

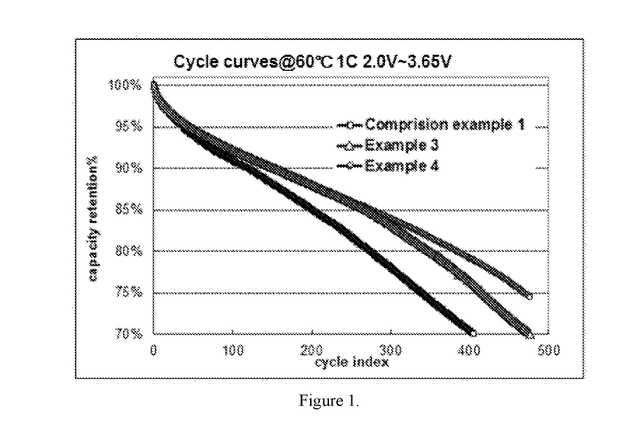

The lithium ion batteries are measured at 60° C./1 C cycle with cut-off voltage range 2.0V˜3.65V by using capacity test cabinet for lithium ion batteries (NEWARE CT-3008W-5V-6A). The results are shown in FIG. 1.

FIG. 1 shows the comparison of cycling performances of LFP batteries at 60° C., and it indicates that the cycle capacity retention of the present LFP batteries is more than 79% after 400 cycles, while the cycle capacity retention of comparison example is less than 70% after 400 cycles.

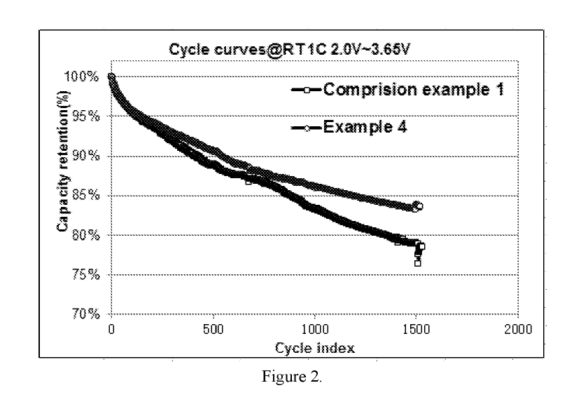

The lithium ion batteries are measured at RT (25° C.)/1 C cycle with cut-off voltage range 2.0V˜3.65V by using capacity test cabinet for lithium ion batteries (NEWARE CT-3008W-5V-6A). The results are shown in FIG. 2.

FIG. 2 shows the comparison of cycling performances of LFP batteries at RT, and it indicates that the cycle capacity retention of the present LFP batteries is more than 84% after 1500 cycles, while the cycle capacity retention of comparison example is less than 77% after 1500 cycles.

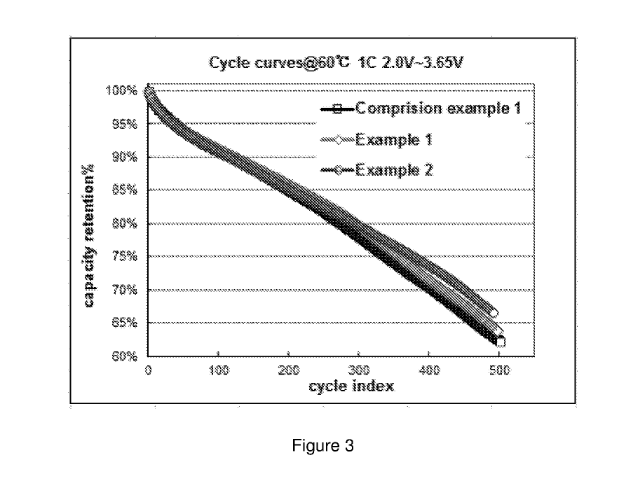

FIG. 3 shows the comparison of cycling performances of LFP batteries at 60° C., and it indicates that the cycle capacity retention of the present LFP batteries is better than the cycle capacity retention of comparison example after 400 cycles.

What is claimed is:

1. A non-aqueous electrolyte composition comprising (a) one or more ionic salts; (b) one or more non-aqueous solvents; and (c) an additive consisting of one or more C₅-C₇ monocycloalkane compounds and derivatives thereof.

2. A non-aqueous electrolyte composition according to claim 1 wherein the C₅-C₇ monocycloalkanes and derivatives thereof are represented by the following chemical formulae: 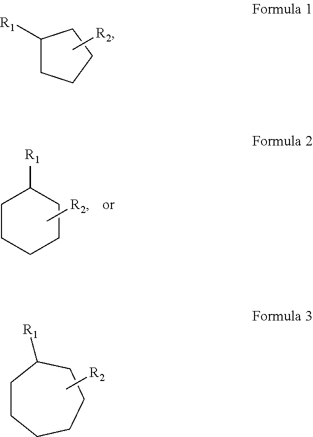
wherein R₁ and R₂ are each independently H, C₁-C₁₀ alkyl, and halogen groups.

3. A non-aqueous electrolyte composition according to claim 2, wherein the R₁-R₂ alkyl substituents are independently C₁-C₈ alkyl.

4. A non-aqueous electrolyte composition according to claim 2, wherein the additive (c) is formula 2: 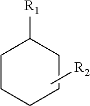
wherein R₁ and R₂ are each independently H, C₁-C₁₀ alkyl, and halogen groups.

5. A non-aqueous electrolyte composition according to claim 1, wherein R₁ is C₁-C₄ alkyl and R₂ is hydrogen.

6. A non-aqueous electrolyte composition according to claim 1, wherein the one or more ionic salts are selected from the group consisting of lithium hexafluorophosphate (LiPF₆), lithium tetrafluoroborate (LiBF₄) and combinations thereof.

7. A non-aqueous electrolyte composition according to claim 1, wherein, the non-aqueous solvent is selected from the group consisting of ethylene carbonate (EC), propylene carbonate (PC), methyl ethyl carbonate (EMC), dimethyl carbonate (DMC), diethyl carbonate (DEC), γ-butyrolactone (GBL), methyl propyl carbonate (MPC), methyl formate (MF), ethyl formate (EF), methyl acetate (MA), ethyl acetate (EA), ethyl propionate (EP), ethyl butyrate (EB), acetonitrile (AN), N,N-dimethyllformamide (DMF) and combinations thereof.

8. A non-aqueous electrolyte composition according to claim 1, wherein the non-aqueous organic solvent is a mixture of two or three solvents selected from the group consisting of ethylene carbonate (EC), propylene carbonate (PC), methyl ethyl carbonate (EMC), dimethyl carbonate (DMC), and diethyl carbonate (DEC).

9. A secondary battery comprising:
a. an anode,
b. a cathode comprised of at least one lithium transition metal phosphate, and,
c. a non-aqueous electrolyte composition comprising (a) one or more ionic salts; (b) one or more non-aqueous solvents; and (c) an additive consisting of one or more C₅-C₇ monocycloalkane compounds and derivatives thereof.

10. The secondary battery of claim 9, wherein the at least one lithium transition metal phosphate (LiMPO₄) is selected from the group consisting of LiFePO₄, LiVPO₄, LiMnPO₄, LiCoPO₄, LiNiPO₄, and LiMnₓMc_{y}PO₄, where Mc is one of or more of Fe, V, Ni, Co, Al, Mg, Ti, B, Ga, and Si and 0<x,y<1.

11. The secondary battery of claim 10, wherein the at least one lithium transition metal phosphate (LiMPO₄) is selected from the group consisting of LiFePO₄, LiMnPO₄ and combinations thereof.

12. The secondary battery of according to claim 9, wherein the solvent is a mixture of one or more solvents selected from the group consisting of ethylene carbonate (EC), propylene carbonate (PC), methyl ethyl carbonate (EMC), dimethyl carbonate (DMC), and diethyl carbonate (DEC).

13. The secondary battery of according to claim 9, wherein the additive (c) is formula 2: 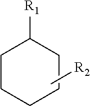
wherein R₁ and R₂ are each independently H, C₁-C₁₀ alkyl, and halogen groups.

14. The secondary battery of claim 13, wherein R₁ is C₁-C₄ alkyl and R₂ is hydrogen.

15. The secondary battery according to claim 9, wherein the one or more ionic salts comprises a salt selected from the group consisting of LiPF₆; LiBf₄, and combinations thereof.
